(19) United States
(12) Patent Application Publication
(10) Pub. No.: US 2021/0143491 A1
(43) Pub. Date: May 13, 2021

(54) BATTERY PACK AND POWER TOOL

(71) Applicant: Nanjing Chervon Industry Co., Ltd., Nanjing (CN)

(72) Inventors: Xunzhuang Qiu, Nanjing (CN); Guillaume Keller, Nanjing (CN); Haibo Zhou, Nanjing (CN)

(21) Appl. No.: 17/082,660

(22) Filed: Oct. 28, 2020

(30) Foreign Application Priority Data
Nov. 7, 2019 (CN) 201911082676.9

(51) Int. Cl. H01M 10/48; H01M 10/42; H01M 2/10; H02J 7/00

(52) U.S. Cl. CPC H01M 10/488; H01M 10/425; B25F 5/00; H02J 7/0047; H01M 2220/30; H01M 2/1022

(57) ABSTRACT

A battery pack includes battery cells, a housing, and a circuit board. The battery cells and the circuit board are arranged inside the housing. The length of the housing is greater than the width of the housing, and the length of the housing is greater than the height of the housing. One of the two sides in the height direction of the housing is provided with a power terminal for outputting electric power. The two sides in the width direction of the housing are respectively provided with a battery charge display device, which includes battery charge indicator lights mounted on the circuit board and electrically connected to the battery cells. The two sides in the width direction of the housing are respectively provided with a window for transmitting light from the battery charge indicator lights.

### RELATED APPLICATION INFORMATION

This application claims the benefit under 35 U.S.C. § 119(a) of Chinese Patent Application No. CN 201911082676.9, filed on Nov. 7, 2019, which application is incorporated herein by reference in its entirety.

### TECHNICAL FIELD

The present disclosure relates to batteries, in particular to a battery pack and a power tool including the battery pack.

### BACKGROUND

With the technological development of battery materials, battery capacity has been greatly improved. Battery packs are widely used in various fields, such as vehicles and various power tools. In order to display battery charge, some existing battery packs are provided with battery charge display devices. Generally, the battery charge display device is arranged at the front or the back of the battery pack. In order to save space occupied by a circuit board inside the battery pack, the circuit board is generally arranged in the middle of the battery pack (that is, the circuit board does not extend to the front or the back of the battery pack), therefore, according to prior art, a separate circuit board arranged inside the battery pack is required for mounting the battery charge display device. However, this kind of design of the battery charge display device has the following shortcomings: as the circuit board needs to be separately arranged to mount the battery charge display device, the circuit board occupies space inside the battery pack, which is not conducive to optimizing the internal space of the battery pack, leading to a large size.

### SUMMARY

In one example of the disclosure, a battery pack includes a plurality of battery cells; a housing; and a circuit board; wherein the plurality of battery cells and the circuit board are both arranged inside the housing, a dimension in a length direction of the housing is greater than a dimension in a width direction of the housing, the dimension in the length direction of the housing is greater than a dimension in a height direction of the housing, one of two sides in the height direction of the housing is provided with a power terminal for outputting electric power, two sides in the width direction of the housing are respectively provided with a battery charge display device, the battery charge display device includes a plurality of battery charge indicator lights, the plurality of battery charge indicator lights are mounted on the circuit board and electrically connected to the plurality of battery cells, and the two sides in the width direction of the housing are respectively provided with a window for transmitting a light from the plurality of battery charge indicator lights.

In one example, the plurality of battery cells is arranged below the circuit board.

In one example, the battery charge display device further includes a light guiding member, the light guiding member includes a plurality of light guiding portions and a display portion, the number of the plurality of light guiding portions is the same as the number of the plurality of battery charge indicator lights, one end of the plurality of light guiding portions directly faces the plurality of battery charge indicator lights, and the other end connects the display portion, and the display portion is arranged in the window.

In one example, the battery charge display device further includes a support member, one end of the support member connects the display portion, and the other end extends toward an inside of the housing; a side of the support member is snap-connected with a side wall of the window.

In one example, each of the plurality of light guiding portion has a large end and a small end opposite to the large end, an area of the large end is larger than that of the small end, the display portion is located on the large end, the battery charge indicator light directly faces the small end, and a cross-sectional area of the light guiding portion gradually increases from the small end to the large end.

In one example, each light guiding portion has two first sides and two second sides arranged between the large end and the small end, the two first sides are respectively arranged up and down at intervals, the two second sides are respectively connected to opposite ends of the first sides, the two second sides form a first acute angle α.

In one example, the plurality of light guiding portions are arranged obliquely, and the plurality of light guiding portions and the two sides in the width direction of the housing form a second acute angle β.

In one example, the display portion connects the plurality of light guiding portions, the display portion is provided with a display surface, the display surface is rectangular, and all of the plurality of battery charge indicator lights in the battery charge display device are distributed at intervals along a length direction of the display surface.

In one example, a ratio of a length of the plurality of display portion to a length of the housing is greater than or equal to 0.2 and less than or equal to 0.8.

In another example of the disclosure, a battery pack includes a housing, wherein a dimension in a length direction of the housing is greater than a dimension in a width direction of the housing, the dimension in the length direction of the housing is greater than a dimension in a height direction of the housing, one of two sides in the height direction of the housing is provided with a power terminal for outputting electric power; a plurality of battery cells arranged in the housing; a circuit board arranged in the housing and electrically connected to the plurality of battery cells; and two battery charge display devices for displaying the remaining power of the battery pack; wherein the two battery charge display devices are respectively arranged on two sides in the width direction of the housing.

In another example of the disclosure, a power tool includes a tool body; and a battery back for powering the tool body; wherein the battery pack includes a plurality of battery cells, a housing and a circuit board, the plurality of battery cells and the circuit board are both arranged inside the housing, a dimension in a length direction of the housing is greater than a dimension in a width direction of the housing, the dimension in the length direction of the housing is greater than a dimension in a height direction of the housing, one of two sides in the height direction of the housing is provided with a power terminal for outputting electric power, two sides in the width direction of the housing are respectively provided with a battery charge display device, the battery charge display device includes a plurality of battery charge indicator lights, the plurality of battery charge indicator lights are mounted on the circuit board and electrically connected to the plurality of battery cells, and the two sides in the width direction of the housing are respectively provided with a window for transmitting the light of the plurality of battery charge indicator lights.

### BRIEF DESCRIPTION OF THE DRAWINGS

FIG. 1 is a structural schematic diagram of an example power tool;

FIG. 2 is an overall schematic diagram of an example battery pack;

FIG. 3 is a plan view of the battery pack with a first housing removed;

FIG. 4 is a perspective view of the battery pack with the first housing removed;

FIG. 5 is a schematic diagram of an example assembly structure of a battery charge display device and a circuit board;

FIG. 6 is a cross-sectional view of the battery pack; and

FIG. 7 is a structural schematic diagram of an example light guiding member.

### DESCRIPTION

As shown in FIGS. 1 and 2, a power tool 100 includes a tool body 10 and a battery pack 20, the battery pack 20 being configured to power the tool body 10. In this example, the power tool 100 is a power drill. It is understood that in other examples, the power tool 100 may also be a torque-outputting power tool, such as a screwdriver, an electric hammer, etc.; the power tool 100 may also be a grinding power tool, such as an angle grinder, etc.; the power tool 100 may also be a sawing power tool, such as a jig saw, a reciprocating saw, an electric circular saws, etc. In fact, as long as the power tool adopts the battery pack 20 of the present invention, it falls within the protection scope of the technical solution of the present invention.

The tool body 10 includes a power output member 10a, a tool housing 10b, and a motor 10c arranged in the tool housing 10b. The tool housing 10b includes a grip portion 10d for a user to grip, the grip portion 10d being arranged symmetrically about a first plane. In particular, the grip portion 10d includes a first grip shell and a second grip shell engaged with the first grip shell, the first grip shell and the second grip shell are respectively distributed along the width direction of a housing 1 of the battery pack, wherein the plane in which the first grip shell and the second grip shell are engaged is the first plane. The battery pack 20 is detachably mounted to the tool housing 10b; the tool housing 10b is formed with a mount portion 10e for mounting the battery pack; the mount portion 10e is also substantially symmetrically arranged about the first plane. The battery pack 20 can be coupled to the mount portion 10e in a first direction 101, and the battery pack 20 can also be removed from the mount portion 10e in a direction opposite to the first direction 101, wherein the first direction 101 and the first plane are parallel to each other.

As shown in FIGS. 2-7, the battery pack 20 includes a plurality of battery cells 4, the housing 1, and a circuit board 3. The battery cells 4 and the circuit board 3 are both arranged inside the housing 1, and at least some of the battery cells 4 are located below the circuit board 3. The two sides of the width direction of the housing 1 are respectively provided with a battery charge display device 2, as shown in FIG. 2 (in FIG. 2, direction X represents the length direction of the housing, direction Y represents the width direction of the housing, and direction Z represents the height direction of the housing). The battery charge display device 2 includes at least two battery charge indicator lights 23, and the battery charge indicator lights 23 are electrically connected to the battery cells 4. The battery charge indicator lights 23 are mounted on the circuit board 3, and the housing 1 is provided with a window 11a for transmitting the light of the battery charge indicator lights 23, wherein the battery charge indicator lights 23 are LED lights. The battery charge indicator lights 23 are directly mounted on the circuit board 3, and the battery charge indicator lights 23 are supported by the circuit board 3. There is no need to additionally provide a separate circuit board to fix the battery charge indicator lights 23 inside the housing 1, which facilitates wiring. In addition, the battery charge display devices 2 are provided on both sides of the width direction of the housing 1, so that there is no need to extend the circuit board 3 to a front side 1c or a back side 1d of the length direction of the housing 1, which shortens the length of the circuit board 3 and optimizes the spatial structure inside the battery pack 20, thereby reducing the size of the battery pack 20.

The two sides of the height direction of the housing 1 are respectively defined as a top side 1a and a bottom side 1b. The top side 1a is provided with a power terminal 1g for outputting power to the tool body 10, and the bottom side 1b is opposite to the top side 1a. The two sides of the length direction of the housing 1 are respectively defined as the front side 1c and the back side 1d. When the battery pack 20 is coupled to the tool body 10, the back side 1d is closer to the tool body 10 than the front side 1c, and the direction from the front side 1c to the rear side 1d is substantially the same as the first direction 101. The two sides of the width direction of the housing 1 are respectively defined as a left side 1e and a right side 1f. The left side 1e is arranged on one side of the first plane, whereas the right side if is arranged on the other side of the first plane. The number of the battery charge display devices 2 is two, one battery charge display device 2 is provided on the left side 1e, and the other battery charge display device 2 is provided on the right side 1f. In this way, when the user holds the power tool 100 with his or her right hand during normal operation of the power tool 100, the user stands at a position slightly to the left of the power tool 100, thus the battery charge display device 2 on the left side 1e is in sight of the user such that the user can easily observe the remaining battery charge of the battery pack 20 in real time without moving or turning head. When the work needs to be done with the power tool 100 is in a left corner to the user, the user needs to hold the power tool 100 with his or her left hand, and stand at a position slightly to the right of the power tool 100, thus the battery charge display device 2 on the right side if is in sight of the user such that the user can easily observe the remaining battery charge of the battery pack 20 in real time without moving or turning head.

In the present example, the battery pack 20 has a first dimension in the length direction, a second dimension in the width direction and a third dimension in the height direction. The first dimension is greater than the second dimension and the third dimension; the second dimension is greater than the third dimension. In this way, the plurality of battery cells 4 can be arranged in sequence along the length direction, and each battery cell 4 can extend in the width direction. This arrangement reduces the size of the battery pack 20 as much as possible. Further, because the dimension of the battery pack 20 in the width direction is greater than the dimension of the battery pack 20 in the height direction, the battery charge display devices 2 can be arranged on both sides of the width direction of the battery pack 20, and the circuit board 3 can be arranged above the plurality of battery cells 4, such that the internal space of the housing 1 is fully utilized, which facilitates the miniaturization of the battery pack 20.

In this example, the circuit board 3 is arranged in the middle of the housing 1, and the circuit board 3 has gaps between both the front side 1c and the back side 1d of the housing 1.

Preferably, referring to FIG. 1, the battery charge display devices 2 are located in the middle of the housing 1. This structure is mainly designed for the circuit board 3 arranged in the middle of the housing 1, which eases the mounting of the battery charge display devices 2. Of course, in actual design, the specific position of the battery charge display devices 2 can be flexibly adjusted according to the position of the circuit board 3 relative to the housing 1.

As a preferred example, the battery charge indicator lights 23 are mounted on the lower surface of the circuit board 3, so that the battery charge indicator lights 23 are hidden in the gap between the battery cells 4 and the circuit board 3, so as to prevent the battery charge indicator lights 23 from occupying effective space inside the battery pack 20.

In another example, the battery charge indicator lights 23 may also be arranged on the upper surface of the circuit board 3. This design eases the difficulty of mounting the battery charge indicator lights 23 and facilitates the cooling of the battery cells 4.

In this example, each battery charge indicator light 23 is arranged on the edge of the circuit board 3.

In order to facilitate the user observing the light of the battery charge indicator lights 23 from the external of the battery pack 20, referring to FIGS. 2-7, the battery charge display device 2 further includes a light guiding member 21. The light guiding member 21 is provided with a plurality of light guiding portions 212 and a display portion 211. The light guiding portions 212 is provided near the battery charge indicator lights 23. One end of a light guiding portion 212 directly faces a battery charge indicator light 23, while the other end connects with the display portion 211. The display portion 211 is mounted in the window 11a. The light of the battery charge indicator lights 23 are guided to the display portion 211 through the light guiding portions 212. Since the display portion 211 is mounted in the window 11a, the user can observe the light of the battery charge indicator lights 23 from the window 11a. This design reduces the diffusion of the light of the battery charge indicator lights 23 inside the housing 1 and facilitates the focus of the light of the battery charge indicator lights 23 at the window 11a. Specifically, the light guiding portions 212 and the display portion 211 are integrally formed, and the number of the light guiding portions 212 is the same as the number of the battery charge indicator lights 23. In this way, the remaining battery charge of the battery pack 20 is displayed by different numbers of lighted battery charge indicator lights 23.

Further, referring to FIG. 3 and FIGS. 5-7, the battery charge display device 2 includes a support member 22; one end of the support member 22 connects the display portion 211, and the other end extends toward the inside of the housing 1 and presses against the battery cells 4 located below support member 22. The light guiding member 21 can be supported on top of the battery cells 4 by the support member 22, so that the display portion 211 is mounted in the window 11a.

In this example, a side of the support member 22 is snap-connected to the side wall of the window 11a. Specifically, one end of the support member 22 away from the display portion 211 is provided with a limiting protrusion 24, and the limiting protrusion 24 is arranged at an angle with the display portion 211, so that the limiting protrusion 24 and the support member 22 form a limiting hook. The limiting protrusion 24 is hooked to the inner side of the housing 1 near the window 11a, so that the side of the support member 22 and the side wall of the window 11a are snap-connected. During the mounting process, the light guiding member 21 is pushed outward from the inside of the housing 1 at a position corresponding to the window 11a, and the limiting protrusion 24 on the limiting hook could be tightly hooked with the inside of the housing 1. During the process of pushing the light guiding member 21, to facilitate mounting, do not push too hard so as to prevent the light guiding member 21 from being pushed to the outside of the housing 1.

As a preferred technical solution, in this example, the support member 22 and the display portion 211 are integrally formed and provided. In other examples, the support member 22 may also be provided separately from the display portion 211.

In another example, the display portion 211 is connected to the window 11a by a fixing member, which can also achieve the purposes of preventing the light guiding member 21 from moving left and right and fixing the display portion 211 in the window 11a. Wherein the fixing member may be a fixing screw, such that the display portion 211 could be screwed to the housing 1 through the fixing screw; alternatively, the fixing member may also be fixing glue, such that the display portion 211 could adhere to the housing 1 through fixing glue applied between the display portion 211 and the side wall of the window 11a.

In a further example, the support member 22 may be configured to be slightly larger than the window 11a. Use the side walls of the window 11a to clamp the support member 22 so that the light guiding member 21 is embedded in the window 11a to prevent the light guiding member 21 from moving left and right.

In order to prevent water and dust from entering the battery pack 20 through the gap between the display portion 211 and the window 11a, a sealant may be provided in the gap between the display portion 211 and the side wall of the window 11a, so that seamless connection between the display portion 211 and the housing 1 can be achieved by the sealant.

Specifically, the inner sides of the display portion 211 are respectively connected with one end of each light guiding portion 212 away from the battery charge indicator light 23.

In an example, each light guiding portion 212 has a large end and a small end disposed opposite the large end. The area of the large end is larger than the area of the small end; the display portion is located on the large end; the battery charge indicator light 23 is arranged near the small end, and the battery charge indicator light directly faces the small end; the cross-sectional area of the light guiding portion 212 gradually increases from the small end to the large end. Light guiding portions 212 of this structure can transmit the light emitted from the battery charge indicator lights 23 from the inside of housing 1 to the outside of the housing 1, reducing the diffusion of the light of the battery charge indicator lights 23 inside the housing 1, and facilitating the focus of the light of the battery charge indicator lights 23 at the window 11a.

In one example, each light guiding portion 212 includes two first sides 213 and two second sides 214 located between the large end and the small end. The two first sides 213 are respectively arranged up and down at intervals. The two second sides 214 are respectively connected to opposite ends of the first sides 213. The two first sides 213, the two second sides 214, the large end and the small end enclose a hexahedral structure to form the light guiding portion 212. This design makes the cross section of the light guiding portion 212 between the large end and the small end a trapezoid. Specifically, the two second sides 214 are respectively inclined toward a symmetry plane of the light guiding member 21 from an end close to the display portion 211 to an end away from the display portion 211, so that the two second sides form a first acute angle α, wherein 10°≤α≤40°. In the present example, the first acute angle α is 19°.

In another example, the light guiding portion may further include a first side, a second side and a third side sequentially connected between the large end and the small end. The first side, the second side, the third side, the large end and the small end enclose a pentahedron structure to form the light guiding portion. This design makes the cross section of the light guiding portion between the large end and the small end a triangle.

In another example, there may be only an arc surface located between the large end and the small end of the light guiding portion. The arc surface, the large end, and the small end enclose a trihedral structure to form the light guiding portion. This design makes the cross section of the light guiding portion between the large end and the small end a circular or an oval.

Of course, in other examples, the light guiding portion may also include a different number of sides and a different number of arc surfaces located between the large end and the small end. The different number of sides, arc surfaces, the large end, and the small end enclose a special-shaped structure to form the light guiding portion, making the cross section of the light guiding portion between the large end and the small end another shape. Alternatively, the light guiding portion may have a rectangular parallelepiped structure, a cylindrical structure, a truncated cone structure or a prismatic structure.

In this example, the light guiding portions 212 are arranged obliquely. The light guiding portions 212 and the two sides of the width direction of the housing 1 form a second acute angle β. Specifically, the two sides of the width direction of the housing 1 are respectively arranged in the vertical direction, and in this example, 20°≤β≤70°. Arranging the light guiding portions 212 and the two sides of the width direction of the housing 1 at the second acute angle β makes the light guiding portions 212 inclined downward to shift the display portion 211 from the intersection of the top side and the two sides of the width direction of the housing 1, reducing the difficulties of assembly.

Further, each battery cell 4 includes a cell body 41 and a cell shell 42 wrapping the cell body 41. At least part of the cell shell 42 is located below the light guiding member 21. The light guiding member 21 inclines downward from an end close to the battery charge indicator light 23 to an end away from the battery charge indicator light 23, and the non-end portion of the light guiding member 21 presses against the cell shell 42. Because the light guiding portion 212 and the two sides of the housing 1 of the width direction form the second acute angle β, and 20°≤β≤70°, the non-end portion of the light guiding member 21 presses against a convex corner of the cell shell 42, thereby providing a supporting force to the light guiding member 21 with the cell shell 42 to perform a certain supporting effect to the light guiding member 21. Further, the resistance between the light guiding member 21 and the non-end portion of the cell shell 42 increases the friction between the light guiding member 21 and the cell shell 42, so as to fix the whole light guiding member 21 to a predetermined location. This design does not require additional fastening structures to fix the light guiding member 21, which further simplifies the internal structure of the battery pack 20.

To further increase the friction between the light guiding member 21 and the cell shell 42 and further reduce the possibility of the light guiding member 21 being displaced relative to the battery cell 4, anti-slip structure is provided on the surface that the light guiding member 21 presses against the cell shell 42, wherein the anti-slip structure may be an anti-slip rubber gasket. Alternatively, the anti-slip structure may be an anti-slip corrugated section is directly provided on the outer surface of the light guiding member 21 or the outer surface of the cell shell 42. It should be noted that specific structures of the anti-slip structure is not limited herein, and any protective structure that increases the friction between the light guiding member 21 and the cell shell 42 is acceptable.

In another example, the light guiding member 21 may be directly placed on the upper surface of the cell shell 42, and the upper surface of the cell shell 42 provides supporting force for the light guiding member 21.

Of course, in other examples, a fastening structure may also be provided to directly fix the light guiding member 21 to the cell shell 42, for example, the light guiding member 21 and the cell shell 42 may be connected by a connecting screw.

Preferably, all the display portions 211 of the same battery charge display device 2 are connected to form a display surface. The display surface is rectangular. The battery charge indicator lights 23 in the same battery charge display device 2 are distributed at intervals along the length direction of the display surface, improving the aesthetics of the battery pack 20. In actual design, the specific shape and structure of the display portion 211 can be flexibly designed according to actual needs, and the shape and structure of the battery panel are not limited herein. In this example, all the display portions 211 of the same battery charge display device 2 are integrally formed. Of course, in other examples, all the display portions 211 of the same battery charge display device 2 may be provided separately.

The ratio of the length of the display portions 211 to the length of the housing 1 is d, wherein 0.2≤d≤0.8, so as to ensure the harmony between the display portions 211 and the housing 1, as well as the easiness to observe the display portions 211.

In this example, with reference to FIG. 2, each battery charge display device 2 includes four battery charge indicator lights 23. The battery charge indicator lights 23 of the same battery charge display device 2 are arranged at intervals. The battery charge indicator lights 23 are sequentially arranged along the length direction of the circuit board 3, and all the display portions 211 in each battery charge display device 2 are connected.

Wherein, the housing 1 includes a first housing 11 and a second housing 12 located below the first housing 11. The first housing 11 and the second housing 12 are connected by a screw assembly. The window 11a is provided on a side of the first housing 11.

Obviously, the foregoing examples are provided merely for the purpose of clearly illustrating the subject battery pack and are not intended to limit the invention claimed. For those of ordinary skill in the art, various obvious changes, readjustments and substitutions fall within the protection scope of the invention claimed. Any modification, equivalent replacement and improvement made within the spirit and principle of the present disclosure shall be included in the protection scope of the claims of the present invention.

What is claimed is:

1: A battery pack, comprising:
a plurality of battery cells;
a housing; and
a circuit board;
wherein the plurality of battery cells and the circuit board are both arranged inside the housing, a dimension in a length direction of the housing is greater than a dimension in a width direction of the housing, the dimension in the length direction of the housing is greater than a dimension in a height direction of the housing, one of two sides in the height direction of the housing is provided with a power terminal for outputting electric power, two sides in the width direction of the housing are respectively provided with a battery charge display device, the battery charge display device comprises a plurality of battery charge indicator lights, the plurality of battery charge indicator lights is mounted on the circuit board and electrically connected to the plurality of battery cells, and the two sides in the width direction of the housing are respectively provided with a window for transmitting light from the plurality of battery charge indicator lights.

2. The battery pack of claim 1, wherein the plurality of battery cells is arranged below the circuit board.

3. The battery pack of claim 1, wherein the battery charge display device further comprises a light guiding member, the light guiding member comprises a plurality of light guiding portions and a display portion, the number of the plurality of light guiding portions is the same as the number of the plurality of battery charge indicator lights, one end of the plurality of light guiding portions directly faces the plurality of battery charge indicator lights and the other end connects with the display portion, and the display portion is arranged in the window.

4. The battery pack of claim 3, wherein the battery charge display device further comprises a support member, one end of the support member connects with the display portion and the other end extends towards an inside of the housing, and a side of the support member is snap-connected with a side wall of the window.

5. The battery pack of claim 3, wherein each of the plurality of light guiding portion has a large end and a small end opposite to the large end, an area of the large end is larger than an area of the small end, the display portion is located on the large end, the battery charge indicator light directly faces the small end, and a cross-sectional area of the light guiding portion gradually increases from the small end to the large end.

6. The battery pack of claim 5, wherein each light guiding portion has two first sides and two second sides arranged between the large end and the small end, the two first sides are respectively arranged up and down at intervals, the two second sides are respectively connected to opposite ends of the first sides, and the two second sides form a first acute angle α.

7. The battery pack of claim 6, wherein the plurality of light guiding portions are arranged obliquely and the plurality of light guiding portions and the two sides in the width direction of the housing form a second acute angle β.

8. The battery pack of claim 1, wherein the display portion connects the plurality of light guiding portions, the display portion is provided with a display surface, the display surface is rectangular, and all of the plurality of battery charge indicator lights in the battery charge display device are distributed at intervals along a length direction of the display surface.

9. The battery pack of claim 8, wherein a ratio of a length of the display portion to a length of the housing is greater than or equal to 0.2 and less than or equal to 0.8.

10. A battery pack, comprising:
a housing, wherein a dimension in a length direction of the housing is greater than a dimension in a width direction of the housing, the dimension in the length direction of the housing is greater than a dimension in a height direction of the housing, and one of two sides in the height direction of the housing is provided with a power terminal for outputting electric power;
a plurality of battery cells arranged in the housing;
a circuit board arranged in the housing and electrically connected to the plurality of battery cells; and
two battery charge display devices for displaying the remaining power of the battery pack;
wherein the two battery charge display devices are respectively arranged on two sides in the width direction of the housing.

11. The battery pack of claim 10, wherein each of the two battery charge display devices comprises a plurality of battery charge indicator lights and a light guiding member for guiding a light emitted by the plurality of battery charge indicator lights.

12. A power tool, comprising:
a tool body; and
a battery back for powering the tool body;
wherein the battery pack comprises a plurality of battery cells, a housing, and a circuit board, the plurality of battery cells and the circuit board are both arranged inside the housing, a dimension in a length direction of the housing is greater than a dimension in a width direction of the housing, the dimension in the length direction of the housing is greater than a dimension in a height direction of the housing, one of two sides in the height direction of the housing is provided with a power terminal for outputting electric power, two sides in the width direction of the housing are respectively provided with a battery charge display device, the battery charge display device comprises a plurality of battery charge indicator lights, the plurality of battery charge indicator lights is mounted on the circuit board and electrically connected to the plurality of battery cells, and the two sides in the width direction of the housing are respectively provided with a window for transmitting the light of the plurality of battery charge indicator lights.

13. The battery pack of claim 12, wherein the plurality of battery cells is arranged below the circuit board.

14. The battery pack of claim 12, wherein the battery charge display device further comprises a light guiding member, the light guiding member comprises a plurality of light guiding portions and a display portion, the number of the plurality of light guiding portions is the same as the number of the plurality of battery charge indicator lights, one end of the plurality of light guiding portions directly faces the plurality of battery charge indicator lights and the other end connects with the display portion, and the display portion is arranged in the window.

15. The battery pack of claim 14, wherein the battery charge display device further comprises a support member, one end of the support member connects the display portion and the other end extends towards an inside of the housing, and a side of the support member is snap-connected with a side wall of the window.

16. The battery pack of claim 14, wherein each of the plurality of light guiding portion has a large end and a small end opposite to the large end, an area of the large end is larger than an area of the small end, the display portion is located on the large end, the battery charge indicator light directly faces the small end, and a cross-sectional area of the light guiding portion gradually increases from the small end to the large end.

17. The battery pack of claim 16, wherein each light guiding portion has two first sides and two second sides arranged between the large end and the small end, the two first sides are respectively arranged up and down at intervals, the two second sides are respectively connected to opposite ends of the first sides, and the two second sides form a first acute angle α.

18. The battery pack of claim 17, wherein the plurality of light guiding portions are arranged obliquely and the plurality of light guiding portions and the two sides in the width direction of the housing form a second acute angle β.

19. The battery pack of claim 12, wherein the display portion connects the plurality of light guiding portions, the display portion is provided with a display surface, the display surface is rectangular, and all of the plurality of battery charge indicator lights in the battery charge display device are distributed at intervals along a length direction of the display surface.

20. The battery pack of claim 19, wherein a ratio of a length of the display portion to a length of the housing is greater than or equal to 0.2 and less than or equal to 0.8.
